(19) United States
(12) Patent Application Publication
(10) Pub. No.: US 2018/0007115 A1
(43) Pub. Date: Jan. 4, 2018

(54) FOG ENABLED TELEMETRY EMBEDDED IN REAL TIME MULTIMEDIA APPLICATIONS

(71) Applicant: Cisco Technology, Inc., San Jose, CA (US)

(72) Inventors: Plamen Nedeltchev, San Jose, CA (US); Srinivas Chivukula, San Jose, CA (US); Ramesh Nethi, San Jose, CA (US); Harish Kolar Vishwanath, San Jose, CA (US)

(21) Appl. No.: 15/201,238

(22) Filed: Jul. 1, 2016

(51) Int. Cl. H04L 29/08

(52) U.S. Cl. CPC H04L 67/02; H04L 67/10; H04L 67/16

(57) ABSTRACT

Disclosed are systems, methods, and computer-readable storage media for fog enabled telemetry in real time multimedia applications. An edge computing device can receive first sensor data from at least a first sensor and a collaboration data stream from a first client device. The collaboration data stream can including at least one of chat, audio or video data. The edge computing device can convert the first sensor data into a collaboration data stream format, yielding a first converted sensor data, and then embed the first converted sensor data into the collaboration data stream, yielding an embedded collaboration data stream. The edge computing device can then transmit the embedded collaboration data stream to an intended recipient.

### TECHNICAL FIELD

This disclosure relates in general to the field of computer networks and, more particularly, pertains to fog enabled telemetry in real time multimedia applications.

### BACKGROUND

Online interactive collaboration applications, like WebEx video conferences, Video chatting, Telepresence, etc., are increasingly being used in areas like tele-medicine, remote expert consulting/counselling, remote expert diagnostics, remote support and other similar services. With the advent of cloud/Internet of Things (IoT) technology and sensor telemetry, more and more machine controllers and sensors are connecting to the network and new data is being generated, potentially allowing applications and service providers to deliver better services to their users and customers. Combining data generated by these intelligent devices (e.g., things) with collaboration applications, however, can be difficult. The data generated by intelligent devices are often sent over dedicated channels to device specific applications in the cloud, where analytics and decision making systems process the data and extract insights. Accordingly, improvements are needed.

### BRIEF DESCRIPTION OF THE DRAWINGS

In order to describe the manner in which the above-recited features and other advantages of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting its scope, the principles herein are described and explained with additional specificity and detail through the use of the accompanying drawings in which:

FIG. 1 illustrates an exemplary configuration of computing devices and a network in accordance with the invention;

FIG. 2 illustrates an example of data communications between computing devices for fog enabled telemetry in real time multimedia application;

FIG. 3 illustrates an example method for fog enabled telemetry in real time multimedia applications; and

FIGS. 4A and 4B illustrate exemplary possible system embodiments.

### DESCRIPTION OF EXAMPLE EMBODIMENTS

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

### Overview:

Disclosed are systems, methods, and computer-readable storage media for fog enabled telemetry in real time multimedia applications. An edge computing device can receive first sensor data from at least a first sensor and a collaboration data stream from a first client device. The collaboration data stream can include at least one of chat, audio or video data. The edge computing device can convert the first sensor data into a collaboration data stream format, yielding a first converted sensor data, and then embed the first converted sensor data into the collaboration data stream, yielding an embedded collaboration data stream. The edge computing device can then transmit the embedded collaboration data stream to an intended recipient.

### DETAILED DESCRIPTION

Disclosed are systems and methods for fog enabled telemetry in real time multimedia applications. Sensor data from one or more sensors communicating via one or more IOT protocols can be embedded into a collaboration data stream to enhance collaboration between user participants in the collaboration session. For example, sensor data collected from a patient, such as heartrate, blood pressure, etc., can be embedded in a collaboration data stream and transmitted to the patient's doctor and used to diagnose the patient. As another example, sensor data describing performance of an industrial machine can be embedded in a collaboration data stream and sent to technician to diagnose performance issues with the industrial machine.

To accomplish this, an edge computing device can be configured using any well defined standard fog interface to receive sensor data from one or more sensors as well as a collaboration data stream from a client device. The collaboration data stream can include one or more of chat, audio or video data being transmitted as part of a collaboration session (e.g., videoconference) with another client device. The edge computing device can convert the sensor data into a collaboration data stream format. This can include normalizing the sensor data into a standard object model. The edge computing device can then embed the converted sensor data into the collaboration data stream, which can be sent to its intended recipient.

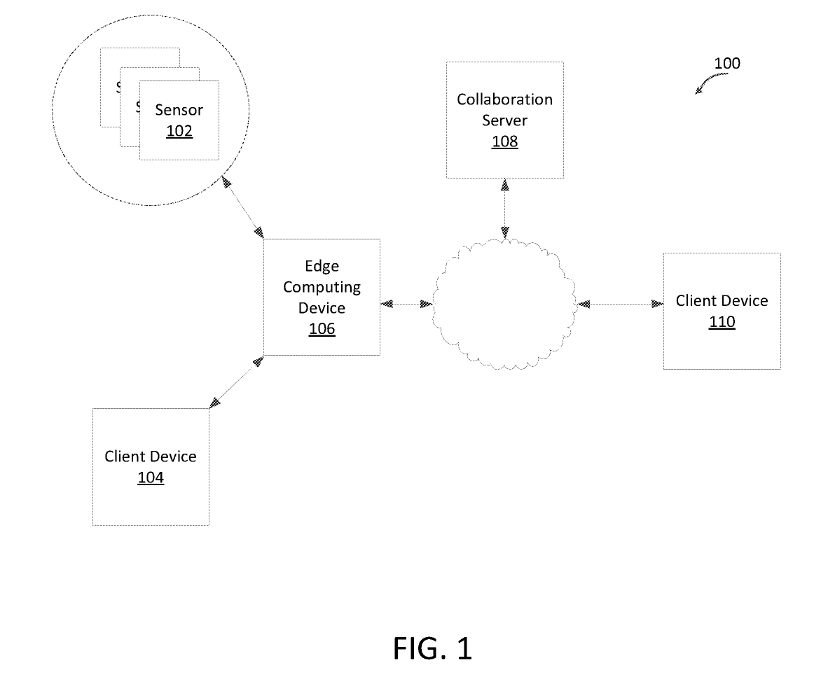

FIG. 1 illustrates an exemplary configuration 100 of computing devices and a network in accordance with the invention. The computing devices can be connected to a communication network and be configured to communicate with each other through use of the communication network. A communication network can be any type of network, including a local area network (“LAN”), such as an intranet, a wide area network (“WAN”), such as the internet, or any combination thereof. Further, a communication network can be a public network, a private network, or a combination thereof. A communication network can also be implemented using any number of communication links associated with one or more service providers, including one or more wired communication links, one or more wireless communication links, or any combination thereof. Additionally, a communication network can be configured to support the transmission of data formatted using any number of protocols.

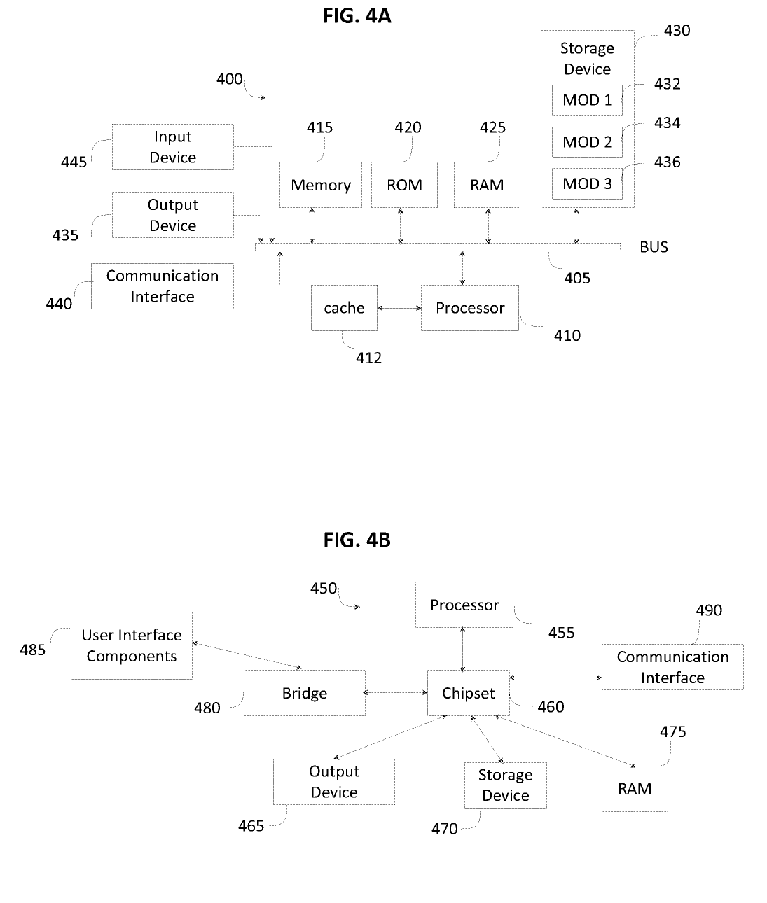

A computing device can be any type of general computing device capable of network communication with other computing devices. For example, a computing device can be a personal computing device such as a desktop or workstation, a business server, or a portable computing device, such as a laptop, smart phone, a tablet PC or a router with a build in compute and storage capabilities. A computing device can include some or all of the features, components, and peripherals of computing device 400 of FIGS. 4A and 4B.

To facilitate communication with other computing devices, a computing device can also include a communication interface configured to receive a communication, such as a request, data, etc., from another computing device in network communication with the computing device and pass the communication along to an appropriate module running on the computing device. The communication interface can also be configured to send a communication to another computing device in network communication with the computing device.

As shown, system 100 includes sensors 102, client device 104, edge computing device 106, collaboration server 108 and client device 110. Collaboration server 108 can be configured to facilitate a collaboration session between two or more client devices. A collaboration session can be a continuous exchange of collaborations data (e.g., video, text, audio, signaling) between computing devices that enables users of the computing devices to communicate and collaborate. Examples of a collaboration session include WebEx video conferences, Video chatting, Telepresence, etc. Client devices 104 and 110 can include software enabling client devices 104 and 110 to communicate with collaboration server 108 to establish a collaboration session between client devices 104 and 110.

Once a communication session is established, client devices 104 and 110 can collect collaboration data (e.g., video, audio, chat) and transmit the collaboration data to collaboration server 108 as a collaboration data stream. Collaboration server 108 can receive collaboration data streams from client devices 104 and 110 and transmit the data to its intended recipient. For example, collaboration server 108 can receive a collaboration data stream from client device 104 and transmit the collaboration data stream to client device 110. Likewise, collaboration server 108 can receive a collaboration data stream from client device 110 and transmit the collaboration data stream to client device 104.

Edge computing device 106 can be configured to embed a collaboration data stream with sensor data gathered from sensors 102. Edge computing device 106 can be an IOx enabled edge device such as a fog device, gateway, home cloud, etc. Sensors 102 can be any type of sensors capable of gathering sensor data. For example, a sensor 102 can be a medical sensor configured to gather sensor data from a human user, such as a heartrate monitor, blood pressure monitor, thermometer, etc. As another example, a sensor 102 can be a machine sensor configured to gather sensor data from a machine, such as a network sensor, temperature sensor, performance sensor, etc.

As shown, edge computing device 106 can receive a collaboration data stream from client device 104 as well sensor data captured by sensors 102. Edge computing device 104 can act as an intelligent proxy collecting data from sensors 102. To communicate with sensors 102, edge computing device 106 can include one or more IoT protocol plugins corresponding to the sensors, such as Modbus, Distributed Network Protocol (DNP3), Constrained Application Protocol (CoAP), Message Queue Telemetry Transport (MQTT), etc. Edge computing device 106 can have an extensible architecture that can provision the required protocol plugin from an online plugin repository on the basis of devices configured for monitoring. Sensors 102 and edge computing device 106 can utilize the appropriate protocol to register the sensors with edge computing device 106, after which edge computing device 106 can begin periodically polling sensors 102 for sensor data.

Edge computing device 106 can convert the received sensor data into a collaboration data stream format such that the sensor data can be embedded within the collaboration data stream received from client device 102. For example, edge computing device 106 can normalize the sensor data to a standard object model for collaboration protocols. Examples of collaboration protocols are Extensible Messaging and Presence Protocol (XMPP) and Data Distribution Service (DDS), which are used by some collaboration tools.

Edge computing device 106 can use network authentication methods to associate client device 104 with a user identity and identify the sensors to poll and embed the data in to the collaboration stream based on a network policy configuration. Edge computing device 106 can further apply sampling and compression to the sensor data to limit the amount and size of sensor data included in the collaboration data stream. For example, edge computing device 106 can apply policies to process sensor data locally for the purposes of locally significant analytics with a small footprint.

Additionally, edge computing device 106 can utilize a software version of traffic classification and tagging, for example at the egress interfaces of edge computing device 106. A modified metadata framework can be used to associate the sensor data stream and augment the collaboration data stream. As an example, a Webex flow classification can be changes as follows:

class-map match-any classify-webex-meeting

match class-map webex-video

match class-map webex-data

match class-map webex-streaming

match class-map webex-sharing

match application webex-meeting

match application all-things-sensors-data

match application all-things-sensors-telemetry

After properly classification is completed, edge computing device 104 can handle routing, securing and/or Quality of Service (QOS) for both sensor data and collaboration data using conventional methods. Edge computing device 104 can transmit the embedded collaboration data stream to collaboration server 108, where the collaboration data can be forwarded to its intended recipient (e.g., client device 110).

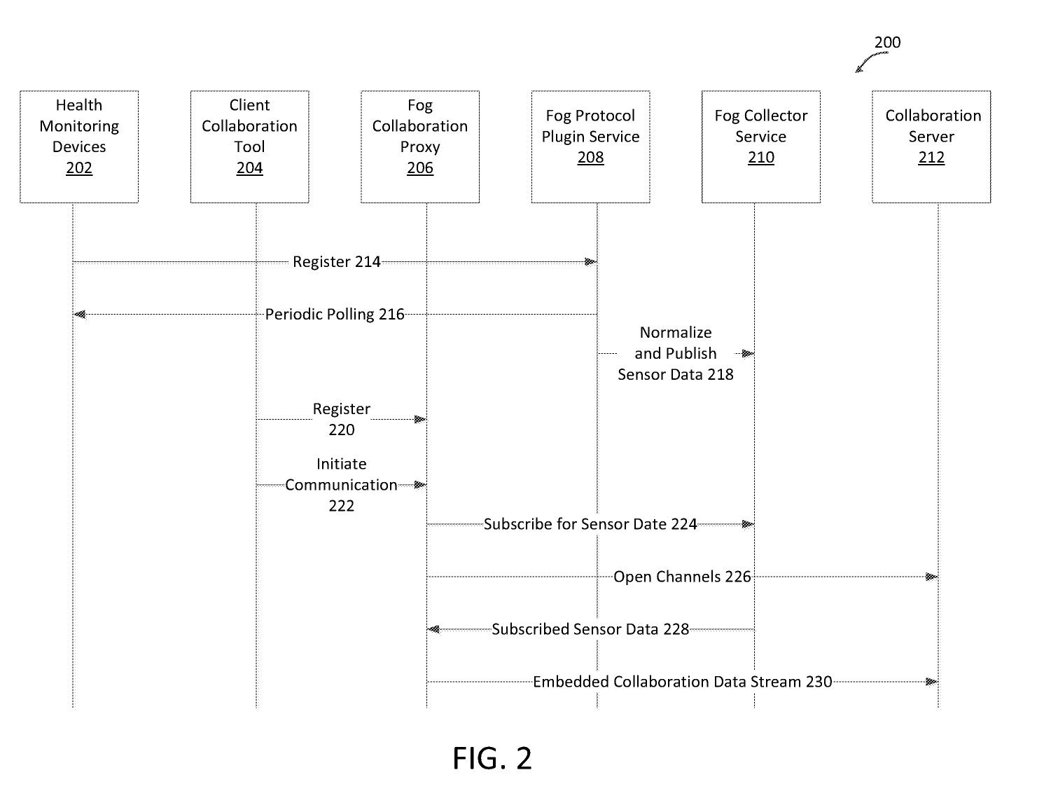

FIG. 2 illustrates an example of data communications between computing devices for fog enabled telemetry in real time multimedia applications. As shown, sensors 202, client collaboration tool 204, Fog protocol plugin 208, fog collector service 210 and collaboration server 212 can communicate with each other to provide fog enabled telemetry in real time multimedia applications. As show, sensors 202 can communicate with fog protocol plugin service 206 running on an edge computing device to register 214 the sensors. For example, the sensors can communicate with the protocol plugin service using an IoT protocol such as Modbus, DNP3, CoAP, MQTT, etc. After sensors 202 are registered with fog protocol plugin service 208, fog protocol plugin 208 can communicate with sensors to periodically poll 216 sensors 202 for sensor data. Fog protocol plugin service 208 can then communicate with fog collector service 210 to normalize and publish the sensor data 218. This can include converting the sensor data into a collaboration data stream format for inclusion in a collaboration session.

Client collaboration tool 204 running on a client device can communicate with fog collaboration proxy 206 running on the edge computing device to register 220 client collaboration tool 204. Client collaboration tool 204 can then initiate communication 222 with fog collaboration proxy 206 to begin a collaboration session and transmit collaboration data to fog collaboration proxy 206. In response to initiating communication with client collaboration tool 204, fog collaboration proxy 206 can communicate with fog collector service 224 to subscribe for the sensor data 224 received from sensors 202. Fog collaboration proxy 206 can also communicate with collaboration server 212 to open channels 226 to initiate a collaboration session and send/receive a collaboration data stream.

Fog collaboration proxy 206 can then receive the subscribed sensor data 228 from fog collector service 210. Fog collaboration proxy 206 can then embed the sensor data into a collaboration data stream and transmit the embedded collaboration data stream 230 to collaboration server 212 for delivery to an intended recipient as part of the collaboration session.

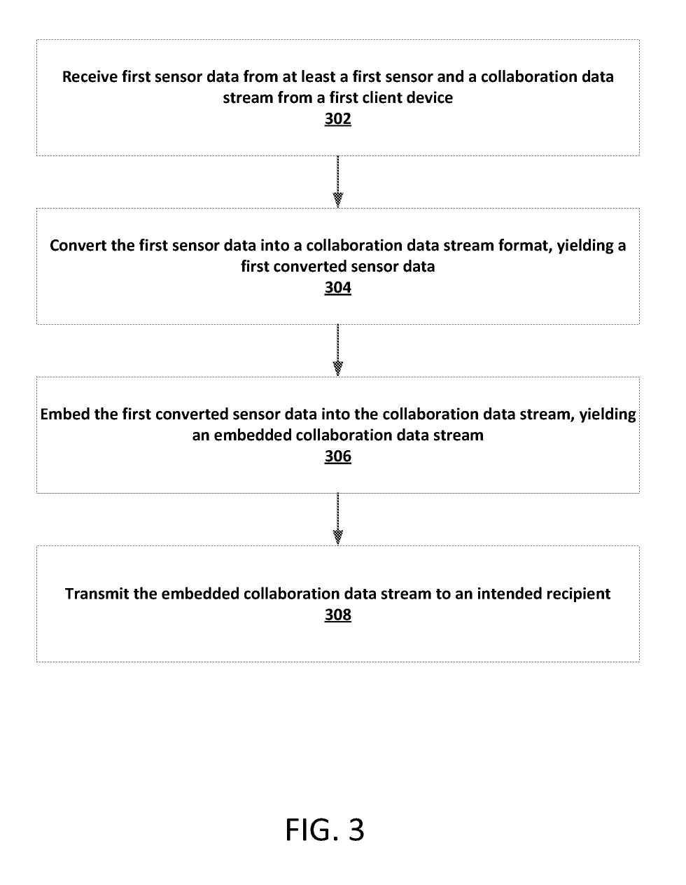

FIG. 3 illustrates an example method for fog enabled telemetry in real time multimedia applications. It should be understood that there can be additional, fewer, or alternative steps performed in similar or alternative orders, or in parallel, within the scope of the various embodiments unless otherwise stated.

At step 302, an edge computing device can receive first sensor data from at least a first sensor and a collaboration data stream from a first client device. The collaboration data stream can including at least one of chat, audio or video data. The edge computing device 106 can include one or more IoT protocol plugins to communication with the sensors, such as Modbus, DNP3, CoAP, MQTT, etc. The sensors and edge computing device can utilize the appropriate protocol to register the sensors with the edge computing device, after which the edge computing device can begin periodically polling the sensors for the sensor data.

At step 304, the edge computing device can convert the first sensor data into a collaboration data stream format, yielding a first converted sensor data. For example, the edge computing device can normalize the sensor data to a standard object model for collaboration protocols. Examples of collaboration protocols are Extensible Messaging and Presence Protocol (XMPP) and Data Distribution Service (DDS), which are used by some collaboration tools.

At step 306, the edge computing device can embed the first converted sensor data into the collaboration data stream, yielding an embedded collaboration data stream.

At step 308, the edge computing device can transmit the embedded collaboration data stream to an intended recipient. For example, the edge computing device can transmit the embedded collaboration data stream to a collaboration server that will forward the collaboration data stream to one or more client devices included in the corresponding collaboration session.

FIGS. 4A and 4B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 4A illustrates a conventional system bus computing system architecture 400 wherein the components of the system are in electrical communication with each other using a bus 405. Exemplary system 400 includes a processing unit (CPU or processor) 410 and a system bus 405 that couples various system components including the system memory 415, such as read only memory (ROM) 420 and random access memory (RAM) 425, to the processor 410. The system 400 can include a cache of high-speed memory connected directly with, in close proximity to, or integrated as part of the processor 410. The system 400 can copy data from the memory 415 and/or the storage device 430 to the cache 412 for quick access by the processor 410. In this way, the cache can provide a performance boost that avoids processor 410 delays while waiting for data. These and other modules can control or be configured to control the processor 410 to perform various actions. Other system memory 415 may be available for use as well. The memory 415 can include multiple different types of memory with different performance characteristics. The processor 410 can include any general purpose processor and a hardware module or software module, such as module 1 432, module 2 434, and module 3 436 stored in storage device 430, configured to control the processor 410 as well as a special-purpose processor where software instructions are incorporated into the actual processor design. The processor 410 may essentially be a completely self-contained computing system, containing multiple cores or processors, a bus, memory controller, cache, etc. A multi-core processor may be symmetric or asymmetric.

To enable user interaction with the computing device 400, an input device 445 can represent any number of input mechanisms, such as a microphone for speech, a touch-sensitive screen for gesture or graphical input, keyboard, mouse, motion input, speech and so forth. An output device 435 can also be one or more of a number of output mechanisms known to those of skill in the art. In some instances, multimodal systems can enable a user to provide multiple types of input to communicate with the computing device 400. The communications interface 440 can generally govern and manage the user input and system output. There is no restriction on operating on any particular hardware arrangement and therefore the basic features here may easily be substituted for improved hardware or firmware arrangements as they are developed.

Storage device 430 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 425, read only memory (ROM) 420, and hybrids thereof.

The storage device 430 can include software modules 432, 434, 436 for controlling the processor 410. Other hardware or software modules are contemplated. The storage device 430 can be connected to the system bus 405. In one aspect, a hardware module that performs a particular function can include the software component stored in a computer-readable medium in connection with the necessary hardware components, such as the processor 410, bus 405, display 435, and so forth, to carry out the function.

FIG. 4B illustrates a computer system 450 having a chipset architecture that can be used in executing the described method and generating and displaying a graphical user interface (GUI). Computer system 450 is an example of computer hardware, software, and firmware that can be used to implement the disclosed technology. System 450 can include a processor 455, representative of any number of physically and/or logically distinct resources capable of executing software, firmware, and hardware configured to perform identified computations. Processor 455 can communicate with a chipset 460 that can control input to and output from processor 455. In this example, chipset 460 outputs information to output 465, such as a display, and can read and write information to storage device 470, which can include magnetic media, and solid state media, for example. Chipset 460 can also read data from and write data to RAM 475. A bridge 480 for interfacing with a variety of user interface components 485 can be provided for interfacing with chipset 460. Such user interface components 485 can include a keyboard, a microphone, touch detection and processing circuitry, a pointing device, such as a mouse, and so on. In general, inputs to system 450 can come from any of a variety of sources, machine generated and/or human generated.

Chipset 460 can also interface with one or more communication interfaces 490 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 455 analyzing data stored in storage 470 or 475. Further, the machine can receive inputs from a user via user interface components 485 and execute appropriate functions, such as browsing functions by interpreting these inputs using processor 455.

It can be appreciated that exemplary systems 400 and 450 can have more than one processor 410 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A method comprising:
receiving, by an edge computing device, first sensor data from at least a first sensor and a collaboration data stream from a first client device, the collaboration data stream including at least one of chat, audio or video data;
converting, by the edge computing device, the first sensor data into a collaboration data stream format, yielding a first converted sensor data;
embedding the first converted sensor data into the collaboration data stream, yielding an embedded collaboration data stream; and
transmitting the embedded collaboration data stream to an intended recipient.

2. The method of claim 1, wherein the edge computing device utilizes a first pluggable Internet of Things (IoT) protocol to communicate with the first sensor to receive the sensor data.

3. The method of claim 2, wherein the first pluggable IoT protocol is one of Modbus, Distributed Network Protocol (DNP3), Constrained Application Protocol (CoAP) or Message Queue Telemetry Transport (MQTT).

4. The method of claim 1, wherein converting the sensor data in a collaboration data stream format comprises:
normalizing the sensor data to a standard object model of a collaboration protocol.

5. The method of claim 4, wherein the collaboration protocol is one of Extensible Messaging and Presence Protocol (XMPP) and Data Distribution Service (DDS).

6. The method of claim 1, further comprising:
receiving second sensor data from a second sensor, the edge computing device utilizing a second pluggable IoT protocol to communicate with the second sensor;
converting the second sensor data into the collaboration data stream format, yielding second converted sensor data; and
embedding the second converted sensor data into the collaboration data stream to yield the embedded collaboration data stream.

7. The method of claim 1, further comprising:
associating the first sensor data with the first client device.

8. An edge computing device comprising:
one or more computer processors; and
a memory storing instructions that, when executed by the one or more computer processors, cause the edge computing device to:
receive first sensor data from at least a first sensor and a collaboration data stream from a first client device, the collaboration data stream including at least one of chat, audio or video data;
convert the first sensor data into a collaboration data stream format, yielding a first converted sensor data;
embed the first converted sensor data into the collaboration data stream, yielding an embedded collaboration data stream; and
transmit the embedded collaboration data stream to an intended recipient.

9. The edge computing device of claim 8, wherein the edge computing device utilizes a first pluggable Internet of Things (IoT) protocol to communicate with the first sensor to receive the sensor data.

10. The edge computing device of claim 9, wherein the first pluggable IoT protocol is one of Modbus, Distributed Network Protocol (DNP3), Constrained Application Protocol (CoAP) or Message Queue Telemetry Transport (MQTT).

11. The edge computing device of claim 8, wherein converting the sensor data in a collaboration data stream format comprises:
normalizing the sensor data to a standard object model of a collaboration protocol.

12. The edge computing device of claim 11, wherein the collaboration protocol is one of Extensible Messaging and Presence Protocol (XMPP) and Data Distribution Service (DDS).

13. The edge computing device of claim 8, wherein the instructions further cause the edge computing device to:
receive second sensor data from a second sensor, the edge computing device utilizing a second pluggable IoT protocol to communicate with the second sensor;
convert the second sensor data into the collaboration data stream format, yielding second converted sensor data; and
embed the second converted sensor data into the collaboration data stream to yield the embedded collaboration data stream.

14. The edge computing device of claim 8, wherein the second pluggable IoT protocol is different than the first pluggable IoT protocol.

15. A non-transitory computer-readable medium storing instructions that, when executed by an edge computing device, cause the edge computing device to:
receive first sensor data from at least a first sensor and a collaboration data stream from a first client device, the collaboration data stream including at least one of chat, audio or video data;
convert the first sensor data into a collaboration data stream format, yielding a first converted sensor data;
embed the first converted sensor data into the collaboration data stream, yielding an embedded collaboration data stream; and
transmit the embedded collaboration data stream to an intended recipient.

16. The non-transitory computer-readable medium of claim 15, wherein the edge computing device utilizes a first pluggable Internet of Things (IoT) protocol to communicate with the first sensor to receive the sensor data.

17. The non-transitory computer-readable medium of claim 16, wherein the first pluggable IoT protocol is one of Modbus, Distributed Network Protocol (DNP3), Constrained Application Protocol (CoAP) or Message Queue Telemetry Transport (MQTT).

18. The non-transitory computer-readable medium of claim 15, wherein converting the sensor data in a collaboration data stream format comprises:
normalizing the sensor data to a standard object model of a collaboration protocol.

19. The non-transitory computer-readable medium of claim 18, wherein the collaboration protocol is one of Extensible Messaging and Presence Protocol (XMPP) and Data Distribution Service (DDS).

20. The non-transitory computer-readable medium of claim 15, wherein the instructions further cause the edge computing to:
receive second sensor data from a second sensor, the edge computing device utilizing a second pluggable IoT protocol to communicate with the second sensor, wherein the second pluggable IoT protocol is different than the first pluggable IoT protocol;
convert the second sensor data into the collaboration data stream format, yielding second converted sensor data; and
embed the second converted sensor data into the collaboration data stream to yield the embedded collaboration data stream.
